(19) United States
(12) Patent Application Publication
(10) Pub. No.: US 2007/0152354 A1
(43) Pub. Date: Jul. 5, 2007

(54) Method for producing alkyl lithium compounds and aryl lithium compounds by monitoring the reaction by means of ir-spectroscopy

(76) Inventors: Wilfried Weiss, Eschershausen (DE); Dirk Dawidowski, Frankfurt (DE); Valter Pleyer, Langolsheim (DE); Frank Kruckel, Liebenburg (DE)

Correspondence Address: FULBRIGHT & JAWORSKI, LLP, 666 FIFTH AVE, NEW YORK, NY, 10103-3198, US

(21) Appl. No.: 10/589,715

(22) PCT Filed: Feb. 24, 2005
(86) PCT No.: PCT/EP05/01954

§ 371 Date: Oct. 23, 2006

(30) Foreign Application Priority Data
Feb. 27, 2004 (DE) 10 2004 009 445.4

(51) Int. Cl. C07F 1/00

(52) U.S. Cl. 260/665 R

(57) ABSTRACT

The invention relates to a method for producing alkyl lithium compounds and aryl lithium compounds by reacting lithium metal with alkyl or aryl halogenides in a solvent, the concentration of the alkyl/aryl halogenide and the alkyl/aryl lithium compound being detected according to an in-line measurement in the reactor by means of IR spectroscopy, and an exact recognition of the end point of the dosing of the halogenide constituents being carried out by evaluation of the IR measurement. Said method enables an optimum reactive process and reaction yield. The identification of the respective concentration of the educt and the product is a reliable reactive process. The yield of the reaction is also optimised by determining the end point of the halogenide dosing, as is the purity of the product due to a lower concentration thereof during the reaction.

The invention concerns a process for producing alkyl lithium compounds and aryl lithium compounds by monitoring the reaction by means of IR spectroscopy.

Alkyl lithium compounds and aryl lithium compounds are produced by reacting lithium metal with alkyl halides and aryl halides respectively. The desired organolithium compound and the corresponding lithium halide form during this process. A more detailed description of this process can be found in WO 95/01982.

The reaction:
2Li+R—Cl=>Li—R+Li—Cl+secondary products
is highly exothermic (dH>−300 kJ/mol) and with an uncertain reaction control it therefore involves a high risk potential. It can also lead to consecutive reactions, such as the known Wurtz reaction:
Li—R+R—Cl=>R—R+Li—Cl
or to secondary reactions due to radicals or radical anions, such as e.g.
Li+R—Cl=>LiCl+R(*)=>radical reactions of R(*)=>
which lead to reductive dehydrohalogenation or conproportionation and thus reduce the purity and yield.

The reaction thus requires continuous reaction monitoring. Reaction inhibitions and the formation of secondary and consecutive products can only be avoided if the concentration of the reactants is known and the reaction performed under optimum conditions.

To ensure a high reaction yield in terms of the alkyl or aryl halide used, lithium is conventionally used in excess, which means a loss in added value, since the metal is obtained by an expensive high-temperature electrolysis process. It is therefore desirable to reduce the excess as far as possible and to use the starting products in as stoichiometric a ratio as possible. In this case, however, there is a risk that the reaction can easily overrun and excess alkyl or aryl halide remain in the final reaction solution, and as a result of the Wurtz reaction which then takes place, soluble or very fine lithium chloride is formed, which interferes with the further use of the product.

Because of the heterogeneous reaction processes, the following difficulties can arise during synthesis:

The start of the reaction can be delayed: the Li metal surface is often rendered inert and a reaction inhibition occurs; accumulated alkyl or aryl halo compound can then spontaneously react, allowing the heat of reaction that is suddenly released to get out of control (cf. WO 96/40692, in which these disadvantageous phenomena are described in detail.)

The course of the reaction can be interrupted: the Li halide which forms during the reaction encrusts the Li metal surface needed for the reaction; the reaction can then come to a standstill. Wurtz coupling
R—Li+R-hal→R—R+Li-hal
(R=alkyl radical or aryl radical, hal=halide)
causes the yield to be reduced. The occurrence of this phenomenon increases with the growing steric stress in the sequence n-, s-, t-alkyl halide. The formation of biphenyls is seen to increase in the aryl halides.

Difficulties with temperature control can lead to high reaction temperatures, at which firstly the undesired Wurtz reaction is encouraged and secondly undesirable decomposition of the alkyl lithium compounds in accordance with
Li—CH₂—CH₂—R→Li—H+CH₂=CH—R
can occur.

If the alkyl or aryl halide is metered in too quickly, it accumulates and, on account of the high reaction heat, harbours an increasing thermal risk. In the same way, the level of secondary and consecutive products increases, which means a lower product yield and undesirably high impurities.

If the alkyl or aryl halide is metered in too slowly, the reaction falls off and comes to a standstill; it has to be restarted, with the aforementioned risks.

An imprecise end-point determination for the reaction leads to alkyl or aryl halide metering errors and hence to yield losses and impurities in the product. On the one hand, the retention of active lithium in the reaction chamber is to be avoided, as this leads to a low yield in terms of lithium and to residues of active lithium, which have to be destroyed in a hazardous process. On the other hand, an overdose of alkyl or aryl halide causes it to remain in the filtered reaction solution, which prolongs the post-reaction time. This in turn leads to consecutive reactions such as the Wurtz reaction, the production yield falls and a particularly fine lithium chloride is formed. This can be detected as ionogenic chloride in the reaction solution for some time and is ultimately precipitated out in very fine form, leading to considerable problems in filtration.

In order to gain control of the listed difficulties, it is desirable always to know the concentration of the alkyl or aryl halide and the concentration of the alkyl or aryl lithium compound in the reaction mixture, in order to be able to draw conclusions about the course of the reaction and also from a safety perspective to be able to avoid an accumulation of heat.

DE 10162332 A1 proposes monitoring the reaction by measuring the heat tonality. This is only a very general method, however, and involves many error quantities, such as thermal transfer and radiation, pressure and temperature fluctuations, etc. DE 10162332 A1 also proposes in general that the alkyl halide content be analysed using an IR spectrometer.

For the dilution of concentrated alkyl lithium solutions, Hardwick (Philip Hardwick, “FT-IR Applications in Alkyllithium Manufacturing”, Fine, Specialty & Performance Chemicals, June 2002) suggests monitoring by means of Fourier-transform IR spectroscopy in the near IR range. Near IR (NIR) is understood to be the wavelength range from 0.75 to 2.5 μm (Römpp, Chemie-Lexikon). The system described by Hardwick provides for the IR light beam to be directed to and from the sample chamber by means of glass fibres, wherein the measurement can take place in transmission or reflection. Sapphire windows are used here. A disadvantage of this system is a non-product-specific measurement in the NIR range, in other words the measurement requires calibrating. Furthermore, this system cannot be used to monitor the reaction of Li metal with alkyl halides because the Li metal attacks the sapphire windows and in this wavelength range it is not possible to distinguish between the overtones of starting material and product that occur.

The object of the invention is therefore to overcome the disadvantages of the prior art and to demonstrate a process in which specifically the concentrations in the reaction mixture of the alkyl halide used and of the alkyl lithium compound obtained are indicated.

The object is achieved by a process for producing alkyl or aryl lithium compounds by reacting lithium metal with alkyl or aryl halides in a solvent, the concentration of the alkyl or aryl halide and the alkyl or aryl lithium compound being determined by inline measurement in the reactor by means of IR spectroscopy.

An optimum reaction control and reaction yield is made possible in this way. A secure reaction control is ensured by this knowledge of the concentration of both starting material and product.

FTIR spectroscopy can be used to determine the solution strengths of starting materials, products and secondary and consecutive products at short intervals of time (e.g. 2 seconds to 2 minutes). With an appropriate set-up, the sensitivity of the measurement can be as low as around 0.01%. IR spectroscopy is thus a suitable means of monitoring the progress of a reaction in solution. IR absorption is linked to concentration by the Lambert-Beer law, with the intensity of absorption serving as a measure. Its relative progress can thus be used without calibration as a semiquantitative criterion for assessment. A defined wavelength range can also be calibrated specifically, however, thus allowing an exact quantitative determination of the concentration.

The benefits of synthesising lithium organyls in the manner described above can be shown as follows:

The solid Li₍ₛ₎ decreases over the course of the reaction with the alkyl/aryl halide (e.g. R—Cl), wherein insoluble Li halide₍ₛ₎ forms, which grows on the Li surface, covers it and stops the desired reaction.

For the reaction rate of the synthesis, the following applies in general:
RR=−1/α*d[R—Cl]/dt=k ₙ[Li—R]^{P}[Li—Cl]^{q}[secondary products]^{r}/[Li]^{s}

The concentrations of R—Cl and Li—R and in certain cases those of the secondary and consecutive products can be determined in the reaction solution by means of IR spectroscopy. The insoluble components Li₍ₛ₎ and LiCl₍ₛ₎ cannot be determined, so the above equation can be simplified and evaluated by means of the concentration progress of R—Cl and R—Li:
RR=−1/α*d[R—Cl]/dt=kₘ[Li—R]^{p}

The progress over time of the concentration profiles for R—Cl and R—Li can thus be used as an aid for assessing the reaction processes. It is now possible to vary the reaction conditions and to assess their influence on the reaction processes. In this way IR spectroscopy becomes a tool for achieving the optimum yield of Li—R, for increasing the product purity and for reducing the formation of secondary and consecutive products, so that a real process optimisation can occur.

A number of optimisation measures are recommended for increasing the sensitivity of the measurement set-up of the FTIR equipment:

The optical path lengths should be kept short and losses through scattered light avoided, which can be achieved by using focusing mirrors. Recent developments seek to develop suitable optical cables.

A particularly sensitive detector is also needed, preferably cooled with liquid nitrogen (MCT detector). Recent developments are focused on the use of Peltier elements. The necessary detection limit for the alkyl or aryl halide is in the range from 0.1 to 0.01%.

It is likewise preferable for the measurements to be performed under a protective gas such as nitrogen or argon. The IR instrument should be operated with explosion protection or, in a non-explosion-proof area, be physically isolated by a protective wall, for example. Should the optical equipment break, a stop valve ensures that the pyrophoric product suspension cannot come into contact with the hot IR source and the electrical components. External influences on the IR source and the laser, such as temperature fluctuations, should be avoided, by means of a special thermostatic control.

The light beam and the IR source must also be protected against moisture and CO₂, which is achieved by scouring with a protective gas such as argon or nitrogen.

It is also necessary to use a voltage regulator and attenuator to ensure stable operation of the instrument and to protect it against power failures.

Instrument control can take place by means of a PLC. The instrument can be controlled by means of specially written macros, which can if necessary be “converted” to another product in which the quantification of starting material and product is stored.

Using a macro, a test can be performed (comparison of master background with newly recorded background), which shows whether the system is operating normally.

Using a window specially built in to the IR instrument, it can be determined from an LED display whether the ball valve has closed because of the intrusion of liquid or excessive pressure in the arm.

The sensor (diamond window) is cleaned after every reaction by means of a submerged tube using a directed spray of the solvent used.

A commercial instrument in the IR range from 600 to 4000 cm⁻¹ is used as the IR instrument (e.g. ASI/Mettler-Toledo: ReactIR or MP). Identification of the alkyl/aryl halide and the alkyl/aryl lithium compound is carried out by means of a substance-specific or statistically determined method (chemometrically e.g. using the Mettler/ASI software ConcIRT) and serves as a basis for the quantitative identification of the concentration of starting material and product, which is determined substance-specifically, e.g. band-specifically in the fingerprint range:

| | cm⁻¹ | | cm⁻¹ |
|---|---|---|---|
| Me-Li = | 957, 1056 | Me-Cl = | 667 |
| Et-Li = | 903, 1077 | Et-Cl = | 660, 973, 1281 |
| n-BuLi = | 968, 1376 | n-BuCl = | 660, 729 |
| | | | 958, 1243 |
| s-BuLi = | 807, 908, 1057 | s-BuCl = | 615, 670, 845 |
| | | | 1158, 1329 |
| i-BuLi = | 799, 938, 1011, | i-BuCl = | 690, 737, 1262 |
| | 1158, 1363 | | |
| t-BuLi = | 772, 945, 1130 | t-BuCl = | 576, 810, 1158, |
| | | | 1270 |
| Hex-Li = | 872, 946, 1042 | Hexyl-Cl = | 652, 729, 1463 |
| Ph-Li = | 702 | Ph-Cl = | 683, 702, 737, |
| | | | 903, 1023, |
| | | | 1085, 1447 |

There are several possibilities for assignment and various processes for evaluation and quantification, such as, for example:
band height, band area
height or area to zero line
height or area to base line
height or area to a base line point
height or area to 2 base line points
or by statistical methods such as P matrix or PLS (partial least square).

The sensitivity of detection of a component can be increased if the solvent is subtracted and/or the changes likewise deducted from one another in a sequence of spectra.

The possibility for quantification arises from the application of the Lambert-Beer law, which describes the relation between absorbed light and substance concentration:
Ig I₀/I=e*c*d=E
according to which absorption at a particular wavelength is proportional to the concentration c and the layer thickness penetrated by the radiation d. The variable I₀/I is the intensity ratio before and after penetration of the sample, Ig is called the absorption and e the absorption coefficient (M. Hesse, Spektroskopische Methoden in der organischen Chemie, Georg Thieme Verlag 1991).

In terms of safety and conversion, the reaction can be optimally controlled by determining the concentration of starting material and product in the reaction mixture. This is preferred when other methods such as measuring the temperature or heat dissipation are too imprecise or entirely out of the question, as is the case with reactions in vacuo, for example, where a simultaneous dependence of pressure/temperature and thermal transfer is difficult. This vacuum mode of operation is preferably used, however, when thermal loading and undesirable secondary and consecutive reactions (Wurtz reaction, decomposition) are to be avoided.

The object of the invention is described in more detail by reference to the following examples. First of all the principle of reaction monitoring by means of IR is described using the example of the synthesis of t-butyl lithium. It is qualitatively illustrated here that to achieve a maximum product yield only a certain amount of t-butyl chloride must be added, in this case therefore not the conventional stoichiometry according to:
2Li+1R-hal=>1R—Li+1LiCl
but instead according to
3Li+1t-BuCl=>1t-BuLi+1Li/1LiCl
is to be maintained, since the lithium is covered by the LiCl and then further penetration of the voluminous t-butyl chloride through the LiCl shell is no longer possible on sterical grounds.

### EXAMPLE 1

### Production of T-Butyl Lithium in Pentane at 20° C., Determination of the Optimum Stoichiometry

10.5 g of lithium powder (1518 mmol) in 300 ml of pentane at 20° C. were placed in a reactor and activated with 10 ml of pre-prepared t-BuLi solution. The addition of 70.3 g of t-butyl chloride (759 mmol=100 mol %) then took place continuously over 144 minutes.

FIG. (1) shows the progress that was observed, with the IR absorption bands for: t-butyl chloride, t-butyl lithium and 2-methyl propene as secondary product.

The reaction course clearly shows that the maximum for t-butyl lithium formation is reached at a metering time of 96 minutes, corresponding to a quantity of 66.6 mol % of t-butyl chloride; continued metering leads to the secondary reaction with the formation of 2-methyl propene and to the breakdown of already formed t-butyl lithium due to a Wurtz reaction. In a semiquantitative analysis, the content of t-butyl lithium falls from the peak of 66% at 108 minutes by 84% to 55% at the end of the reaction=160 minutes (relative).

A product yield of 263 mmol (35% yield) was isolated. On balance this means that with an optimum addition of 66 mol % of t-butyl chloride, a yield of 506 mmol of t-butyl lithium could have been obtained, but through the further addition of 33 mol %=253 mmol of t-butyl chloride this was reduced again to 505−253=251 mmol because of secondary reactions.

The explanation is simple: after the addition of 66.6 mol % the lithium is enclosed by a lithium chloride coating. The t-butyl chloride then diffuses and reacts with conproportionation to form butane and 2-methyl propene and/or reacts under the Wurtz reaction. The conversion of lithium with t-butyl chloride thus takes place most favourably with a stoichiometry according to:
3Li+1t-BuCl=>1t-BuLi+1Li/LiCl
wherein the metering rate for t-butyl chloride must be regulated in such a way that as little as possible accumulates in the reaction solution.

### EXAMPLE 2

### Production of T-butyl Lithium in Cyclohexane at 40° C., Stoichiometry: +83 mol % T-butyl Chloride

13.8 g of lithium powder (1984 mmol) in 180 g of cyclohexane were placed in a 500 ml double-jacket reactor, activated with 6 g of pre-prepared t-BuLi solution and heated to 40° C. A mixture of t-butyl chloride containing 1% MTBE was added.

FIG. (2) shows the reaction course, autoscaled with the y-axis as the IR absorption band for t-butyl chloride (not quantified, i.e. analogously to the Lambert-Beer law).

To start the reaction, 3×1 ml portions of t-butyl chloride were added and the accumulation and subsequent breakdown with formation of t-butyl lithium were detected.

The continuous addition of t-butyl chloride took place in the time from 1.25 hours to 3.0 hours; 76.5 g of t-butyl chloride (826 mmol) were added in total.

From the reaction course it can easily be seen that the t-butyl chloride first accumulates, up to a maximum of 0.0108 absolute at 1.5 hours, and then drops, at 1.7 hours=0.0046 absolute. The t-butyl chloride then rose continuously and more or less uniformly to 0.010 absolute by the end of the metering time after 3 hours, and then fell again during the post-reaction.

The corresponding curve, FIG. (3), with the y-axis as IR absorption band for t-butyl lithium, is shown below.

At the start of the continuous metering process, the IR band height for t-butyl lithium at 1.5 hours=0.0164 absolute. At the end of the metering time the band height at 3.0 hours=0.208 absolute. Then it rose again a little further during the post-reaction, reaching 0.212 absolute at the end after 4 h.

The theoretically calculated value for the yield of t-butyl lithium is 22.8% (826 mmol); 12.7% (410 mmol) were found by analysis, corresponding to a yield of only 50%. Only 62% of the optimum (66.6 mol % based on Li═) 660 mmol was thus obtained. From the comparatively stable final concentration of t-butyl lithium, it can only be concluded that under the specified reaction conditions (40° C. in cyclohexane) considerable secondary reactions occur, i.e. formation of 2-methyl propene and 2-methyl propane (250 mmol=30 mol %) and the Wurtz reaction (166 mmol=20 mol %).

The example shows that to increase the yield it is necessary to keep the concentration of t-butyl chloride as low as possible in order to prevent undesirable secondary reactions.

### EXAMPLE 3

### Production of N-butyl Lithium, Reaction at Boiling Point

A dispersion of approx. 250 kg of lithium powder with a content of 1-3% sodium in 1400 kg of hexane was placed in the reactor. The addition of n-butyl chloride took place in 3 phases with varying metering rates for the start phase, main phase and end phase.

The overall time was approx. 280 minutes (4.6 h). The released reaction heat of approx. 335 kJ/mol butyl chloride served in the 1^{st} phase (starting phase) to heat the reaction mixture from room temperature to boiling point, then during phases 2 and 3 the reaction heat was dissipated by evaporative cooling. With a theoretical quantity of 1632 kg of n-butyl chloride, a product solution with a content of 44.2% butyl lithium (with 100% conversion) would therefore be obtained.

FIGS. (4) and (5) (autoscaled) show the reaction course with the quantified values for n-butyl lithium and n-butyl chloride.

In FIG. (4) the y-axis (in wt. %) is assigned to n-butyl lithium.

In FIG. (5) the x-axis (wt. %) is assigned to n-butyl chloride.

It can be seen that the reaction began almost immediately, but retained a small content of n-butyl chloride during the start phase up to 30 minutes, which then dropped to 0 and rose again at around 3 hours (with a butyl lithium content of around 31%). The metering of n-butyl chloride was stopped at a content of 0.7%. The butyl lithium content here was 41.8%.

1577 kg of n-butyl chloride were added up to this point (280 minutes). The resulting theoretical concentration of n-butyl lithium amounts to 43.3%, whilst a content of 42.1% was found by analysis, corresponding to a yield of 97.1% based on n-butyl chloride.

### EXAMPLE 4

### Production of N-butyl Lithium

The reactor was filled with the Li dispersion as described above and the reaction with n-butyl chloride performed in the manner described. FIG. (6) shows the autoscaled IR diagram with the content of n-butyl chloride as the y-axis.

A slight accumulation of n-butyl chloride can be seen in the start phase and another rise after 3 hours of metering (30.7% of n-butyl lithium); metering was stopped after 4 h 26 minutes, with a content of n-butyl chloride of 0.92% and a metered quantity of 1581 kg.

FIG. (7) shows the corresponding autoscaled diagram with the y-axis as the concentration of n-butyl lithium.

The continuous rise in n-butyl lithium up to the end of the metering time at 4 hours and 44 minutes to a content of 41.0% can be seen; during the post-reaction the butyl lithium content rises slightly to 41.1% after 6 hours and 20 minutes.

The calculated concentration amounts in this case to 43.4% of n-butyl lithium; a content of 41.1% was found by analysis, corresponding to a yield of 94.7%, based on n-butyl chloride.

### EXAMPLE 5

### Production of S-butyl Lithium in Vacuo at 40° C. and under a Pressure of 290 mbar

This example demonstrates that a quantification of the IR bands is not absolutely necessary and that—based on the validity of the Lambert-Beer law—monitoring and semiquantitative analysis of the reaction is also possible from the band height.

A dispersion of 230 kg of lithium and 4 kg of sodium in 1450 kg of hexane was placed in the reactor at room temperature and the vacuum adjusted to 290 mbar. The metering of s-butyl chloride took place in the manner described above, with the reaction being started first of all in a start-up phase. After the start of the reaction the reaction mixture heated up to boiling point (40° C./290 mbar) because of the reaction heat released, and the s-butyl chloride was metered in continuously. The end point of the addition was determined experimentally at a maximum value for the band height of s-butyl chloride at which the maximum yield of s-butyl lithium was obtained.

FIG. (8) shows the IR course with the IR band height for s-butyl chloride as the y-axis in an autoscaled view.

The accumulation of s-butyl chloride can be clearly seen during the start phase, which died down after 1 hour and 15 minutes and is followed by an only gradually increasing content of s-butyl chloride until the addition is stopped after 5 hours and 40 minutes at a band height of 0.00154.

The illustration clearly shows that at the end of the metering period the concentration of s-butyl lithium with an IR height of 0.48 is below the maximum concentration at 5 h 52 minutes with an IR height of 0.49, which is explained by a post-reaction.

See in this connection the corresponding autoscaled representation of the reaction with the y-axis as the IR height for s-butyl lithium: FIG. (9).

A theoretically calculated concentration of 43.8% is compared with a concentration of 41.8% found by analysis, corresponding to a yield of 95.4%, based on s-butyl chloride.

### EXAMPLE 6

### Production of Hexyl Lithium in Vacuo at 40° C. and under a Pressure of 290 mbar

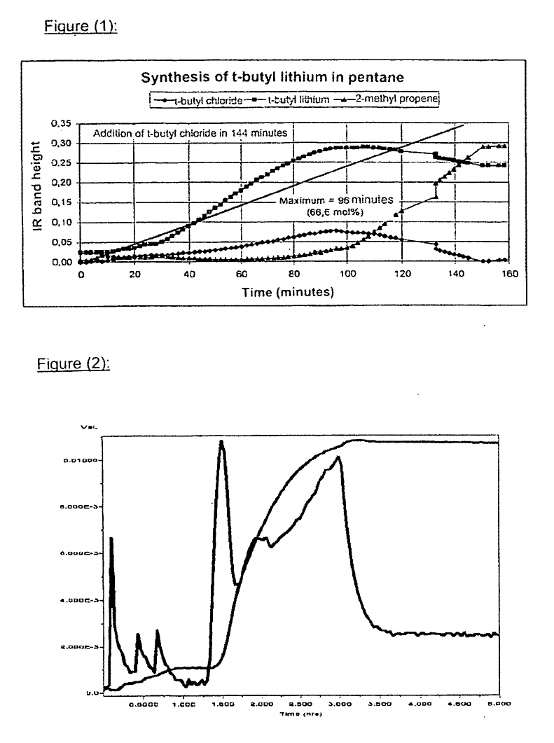

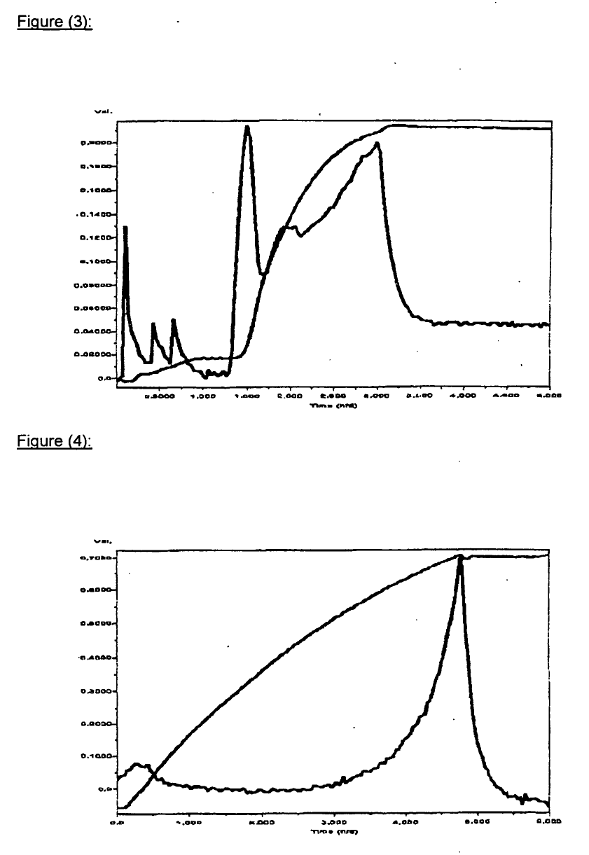

A dispersion of 180 kg of lithium and 4 kg of sodium in 1050 kg of hexane was placed in the reactor at room temperature and the vacuum adjusted to 290 mbar. The metering of n-hexyl chloride took place in the manner described above, with the reaction being started first of all in a start-up phase. After the start of the reaction the reaction mixture heated up to boiling point (40° C./290 mbar) because of the reaction heat released, and the n-hexyl chloride was metered in continuously. The end point was determined at a maximum value for the band height of n-hexyl chloride, which in this case was 1440 kg, corresponding to a theoretical final concentration of 51.1%. A concentration of 48.8% was found, corresponding to a yield of 95.5% based on n-hexyl chloride. The corresponding IR diagram (FIG. 10) with hexyl lithium (relative as ordinate) shows the continuous rise in concentration up to the end of the reaction at 260 minutes (metering time+post-reaction).

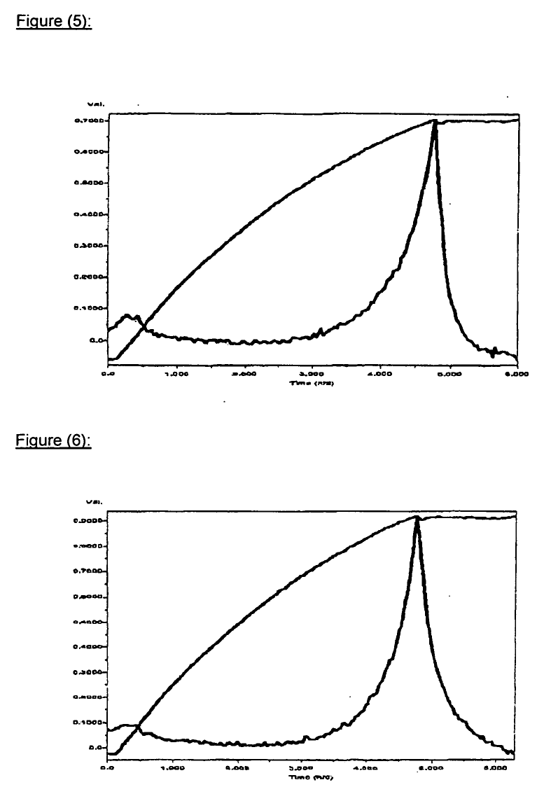

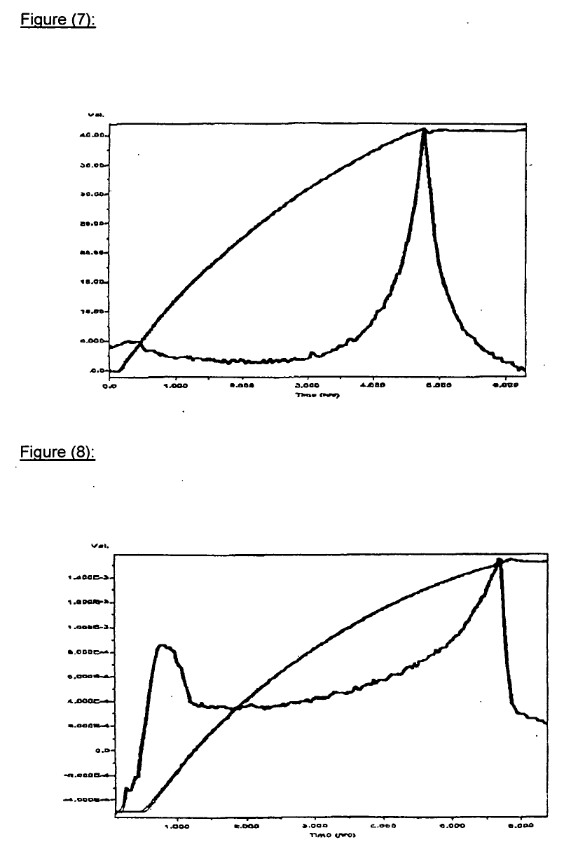

The corresponding IR diagram (FIG. 11) with hexyl chloride (relative as ordinate) shows the accumulation in the reaction mixture from 150 minutes up to the end of metering at 235 minutes (relative IR maximum=0.00264), followed by the rapid drop during the short post-reaction period up to 260 minutes.

### EXAMPLE 7

### Production of Phenyl Lithium in Dibutyl Ether at 35° C.

14.3 g of lithium powder (2065 mmol) together with 0.2 g of lithium hydride in 200 g of dibutyl ether with 0.6 g of biphenyl as catalyst (4 mmol) were placed in a double-jacket reactor at T(i)=35° C. The reaction was initiated by the addition of 2.4 g of chlorobenzene. After the successful start-up of the reaction, 96.5 g of chlorobenzene (857 mmol) were metered in continuously over 4 hours and the post-reaction continued for 2 hours. A sample was taken; with a content of 3.091 mmol of phenyl lithium/g it showed a reaction conversion of 98.3%. The reaction batch was cooled to room temperature and stirred overnight. A new sampling resulted in a content of 3.037 mmol of phenyl lithium/g, corresponding to a conversion of 96.6%, based on chlorobenzene.

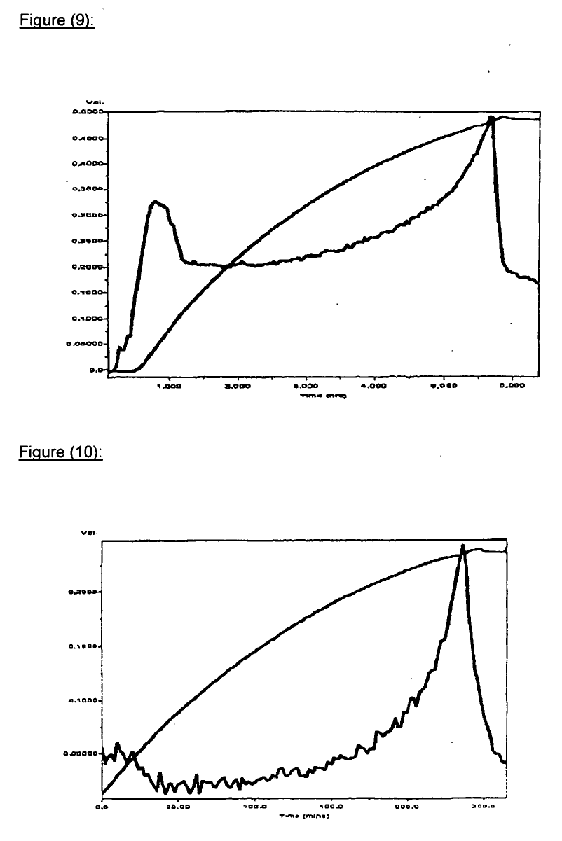

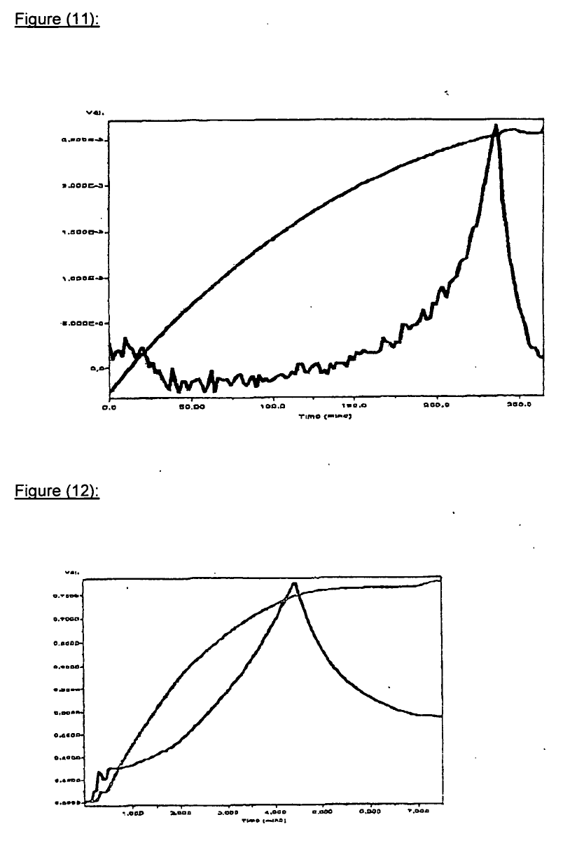

The course of the IR bands for phenyl lithium (relative as ordinate) is shown in FIG. 12.

The start of the reaction and the slow post-reaction after the end of the metering time at 4500 minutes (=chlorobenzene maximum) can be seen.

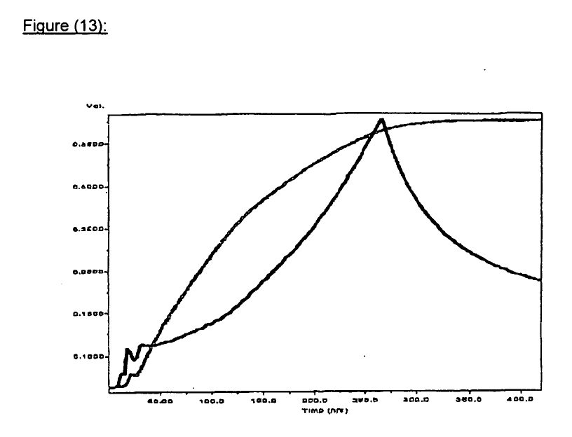

In comparison, the corresponding IR diagram with chlorobenzene (relative as ordinate) shows the delayed rise at the start of the reaction and clearly illustrates the slow die-down during the post-reaction (FIG. 13).

1-9. (canceled)

10. A process comprising producing at least one of an alkyl or aryl lithium compound by reacting lithium metal with at least one alkyl or an aryl halide in at least one solvent, wherein the concentrations of the alkyl halide or the aryl halide and the alkyl or aryl lithium compound are determined by inline measurement in the reactor by IR spectroscopy.

11. A process according to claim 10, wherein an IR spectrometer in the wavelength range from 600 to 4000 cm⁻¹ is used.

12. A process according to claim 10, wherein an absolute total reflection cell (ATR cell) with a diamond sensor and high sensitivity is used as the IR probe, wherein the ATR cell is immersed directly in the reaction mixture and is specially sealed, the measurement set-up being explosion-proof and being scoured with an inert gas, such as argon or nitrogen.

13. A process according to claim 10, wherein the complete measurement set-up is equipped with a safety valve to prevent the release of pyrophoric material in the event of mechanical damage to the sensor.

14. A process according to claim 10, wherein to ensure a stable measurement process the instrument is thermostatically controlled and is protected against external electrical fluctuations.

15. A process according to claim 10, wherein aliphatic (such as methyl lithium, ethyl lithium, propyl lithium, butyl lithium including all isomers, hexyl lithium, octyl lithium) or aromatic lithium alkyl compounds (such as phenyl lithium, tolyl lithium, mesityl lithium) are obtained.

16. A process according to claim 10, wherein the solvent comprises an aliphatic hydrocarbon, a cycloaliphatic hydrocarbon, an aromatic hydrocarbon, an ether, a cycloaliphatic hydrocarbon, an aromatic hydrocarbon or a mixture thereof.

17. A process according to claim 10, wherein the process is performed under normal pressure, in vacuo, or in an overpressure range.

18. A process according to claim 10, wherein the process is performed at temperatures from −120° C. to 100° C.

19. A process according to claim 10, wherein the solvent comprises at least one solvent selected from the group consisting of pentane, hexane, heptane, octane, cyclopentane, cyclohexane, methyl cyclohexane, toluene, xylene, mesitylene diethyl ether, diisopropyl ether, dibutyl ether, methyl tert-butyl ether, tetrahydrofuran, 2-methyl tetrahydrofuran or a mixture thereof.
